(19) United States
(12) Patent Application Publication
(10) Pub. No.: US 2025/0158486 A1
(43) Pub. Date: May 15, 2025

(54) DIRECT DRIVE WHEEL END GENERATOR

(71) Applicant: NIVALIS ENERGY SYSTEMS LLC, HUNT VALLEY, MD (US)

(72) Inventors: Ryan KEMMET, Phoenix, AZ (US); Dustin WRIGHT, Phoenix, AZ (US); Dennis TOWNSEND, Miami, FL (US); Samuel PLUNKETT, Chicago, IL (US); Justin LESNIAK, Milford, MI (US)

(73) Assignee: NIVALIS ENERGY SYSTEMS LLC, HUNT VALLEY, MD (US)

(21) Appl. No.: 18/748,420

(22) Filed: Jun. 20, 2024

Related U.S. Application Data
(60) Provisional application No. 63/599,151, filed on Nov. 15, 2023.

(51) Int. Cl. H02K 7/18; B60C 23/04; B60R 16/03; H02K 16/02

(52) U.S. Cl. CPC H02K 7/1861; B60C 23/041; B60R 16/03; H02K 16/02

(57) ABSTRACT

A direct drive wheel end generator system configured to produce electricity based on a rotation of a wheel hub and a housing around a stationary spindle. The direct drive wheel end generator system may include an electric generator within the housing. The electric generator may include one or more rotors coupled to the housing and one or more stator windings coupled to the spindle. The housing may be coupled to the hub via one or more fasteners extending through one or more holes in the housing and one or more corresponding holes in the hub.

### CROSS REFERENCE TO RELATED APPLICATION

This application claims the benefit of U.S. Provisional Application, Ser. No. 63/599,151, filed on 15 Nov. 2023. The co-pending provisional application is hereby incorporated by reference herein in its entirety and is made a part hereof, including but not limited to those portions which specifically appear hereinafter.

### TECHNICAL FIELD

The present disclosure relates to wheel ends for vehicles and, more specifically, to wheel ends configured to generate electrical power directly from the rotation of the wheels.

### BACKGROUND

A wheel end may include a wheel hub assembly mounted on a spindle of a vehicle axle to provide a rotatable connection point for mounting a wheel and tire assembly to the vehicle. Wheel hub assemblies for commercial vehicles such as heavy-duty trucks come in a variety of configurations depending on whether the wheel is a driven wheel, trailer wheel, or tandem wheel. Wheel hub assemblies generally include a wheel hub and inboard and outboard roller bearings mounted therein that receive the spindle of the vehicle axle.

Many electrified vehicles include regenerative braking systems that use an electric motor to aid in slowing the vehicle and to generate electricity from the rotational motion of the wheel. The generated electrical power may be used to charge a battery of the vehicle and/or power one or more components of the vehicle. To aid in slowing the vehicle, these regenerative braking systems apply torque to wheel hubs of the vehicle by way of a motor. Current regenerative braking systems of vehicles work in conjunction with mechanical friction brakes to slow the vehicle.

### SUMMARY OF THE INVENTION

A direct drive wheel end generator system configured to produce electricity based on a rotation of a wheel hub and a housing around a stationary spindle. The direct drive wheel end generator system may include an electric generator within the housing. The electric generator may include one or more rotors coupled to the housing and one or more stator windings coupled to the spindle. The housing may be coupled to the hub via one or more fasteners (e.g., bolts, pins, or the like) extending through one or more holes in the housing and one or more corresponding holes in the hub.

In an example, the electric generator may be a radial flux motor. The one or more rotors and the one or more stator windings may be orientated such that a majority of their lengths are parallel with a longitudinal axis of the spindle. The one or more rotors may be a single rotor aligned with the longitudinal axis of the spindle. The one or more rotors may include a hollow shaft that extends through an entire longitudinal axis of the one or more rotors. The hollow shaft may extend through an opening in the housing and is coupled to a tube for an automatic tire inflator system. Additional or alternatively, an interior of the housing may be pressurized and coupled to a tube for an automatic tire inflator system.

In another example, the electric generator may be an axial flux motor. The one or more rotors and the one or more stator windings may be orientated such that a majority of their lengths are perpendicular with a longitudinal axis that runs the length of the spindle. The one or more stator windings may be connected to a central stator that is substantially cylindrical in shape. The central stator may be connected to the spindle via a tab that inserts into a keyway on the spindle. A hollow shaft may extend through a middle opening of the central stator and through an opening in the housing and may be coupled to a tube for an automatic tire inflator system. Additionally, or alternatively, an interior of the housing is pressurized and is coupled to a tube for an automatic tire inflator system.

### BRIEF DESCRIPTION OF DRAWINGS

Other objects and advantages of the present disclosure will become apparent to those skilled in the art upon reading the following detailed description of exemplary embodiments and appended claims, in conjunction with the accompanying drawings, in which like reference numerals have been used to designate like elements.

FIG. 1 is a view of semi-truck, a tractor, and a trailer having a regenerative system that includes a direct drive wheel end generator system, according to an example of the present disclosure.

FIG. 2A is a top view of a first type of direct drive wheel end generator system, according to an example of the present disclosure.

FIG. 2B is a top view of an example of the first type of the direct drive wheel end generator system that is configured to incorporate an automatic tire inflator system, according to an example of the present disclosure.

FIG. 2C is a top view of another example of the first type of the direct drive wheel end generator system that is configured to incorporate an automatic tire inflator system, according to an example of the present disclosure.

FIG. 2D is a top view of a second type of direct drive wheel end generator system, according to an example of the present disclosure.

FIG. 2E is a top view of an example of the second type of the direct drive wheel end generator system that is configured to incorporate an automatic tire inflator system, according to an example of the present disclosure.

FIG. 2F is a top view of another example of the second type of the direct drive wheel end generator system that is configured to incorporate an automatic tire inflator system, according to an example of the present disclosure.

FIG. 3A is a top view of a third type of direct drive wheel end generator system, according to an example of the present disclosure.

FIG. 3B is a top view of an example of the third type of the direct drive wheel end generator system that is configured to incorporate an automatic tire inflator system, according to an example of the present disclosure.

FIG. 3C is a top view of another example of the third type of the direct drive wheel end generator system that is configured to incorporate an automatic tire inflator system, according to an example of the present disclosure.

FIG. 4A is a perspective view of the third type of direct drive wheel end generator system, according to an example of the present disclosure.

FIG. 4B is a cross section view of the third type of direct drive wheel end generator system, according to an example of the present disclosure.

FIG. 5 is a cross section view of the third type of direct drive wheel end generator configured to incorporate an automatic tire inflator system, according to an example of the present disclosure.

FIG. 6 is a component diagram of an electrical system incorporating the direct drive wheel end generator system, according to an example of the present disclosure.

The figures are for purposes of illustrating example embodiments, but it is understood that the inventions are not limited to the arrangements and instrumentality shown in the drawings. In the figures, identical reference numbers identify at least generally similar elements.

### DETAILED DESCRIPTION

The present disclosure describes systems, methods, and apparatuses for a direct drive wheel end generator system configured to be mounted to a hub and a spindle of a trailer. The direct drive wheel end generator system may include, at least, an electric generator comprising a coil of wire and at least one magnet configured to move relative to one another with rotation of the wheel hub around the spindle. Further, the direct drive wheel end generator system may include one or more of circuitry and wiring capable of providing a voltage to one or more operating devices and/or storage devices (e.g., batteries) located on the trailer and/or vehicle.

The direct drive wheel end generator system may be directly coupled (i.e., without gears or belts) to an existing hub and spindle assembly of a trailer. The direct drive wheel end generator system may have some components that are coupled to the stationary spindle and some components that are coupled to the rotating hub. For example, the direct drive wheel end generator system may include one or more components that connect to the existing hub. This may allow for components of the direct drive wheel end generator system to be covered and protected from the elements by a hub cap cover (either existing or specifically designed). The direct drive wheel end generator system may also include one or more components that couple to the existing spindle and keyway, allowing the spindle to stay intact as assembled. In an example, the direct drive wheel end generator system may be sensorless (e.g., no resolver or encoder) to reduce the number of wires required to electrically couple the direct drive wheel end generator system to the trailer and/or vehicle components. A wire gland with a welded bung may be used to run any wires that are required through the spindle and a dead axle on the trailer.

As described in additional detail below, the direct drive wheel end generator system may be a low power device, but still capable of producing power needed to operate one or more trailer/vehicle components (e.g., a trailer refrigeration unit (TRU) and/or charge one or more batteries. For example, it is contemplated that certain examples of the direct drive wheel end generator system described herein may produce approximately 5 Wh to approximately 11 kW peak power. Other power outputs are contemplated, and this range is not intended to limit this disclosure.

Further, it is contemplated that any number of direct drive wheel end generator assemblies may be incorporated into a trailer to provide a desired amount of power. For example, a trailer may include a single direct drive wheel end generator system. In another example, a trailer may have multiple direct drive wheel end generator assemblies (e.g., two direct drive wheel end generator assemblies on opposite ends of a single axle).

Because the direct drive wheel end generator system is configured to mount to existing hubs and spindles and fits within the wheel offset (i.e., within the wheel dimension), the direct drive wheel end generator system may allow for the removal of wheels and servicing of the trailer without any substantial changes. Further, the direct drive wheel end generator system may allow for typical wheel end device functionality, such as wheel stud tension monitoring, wheel hub oil temperature monitoring, bearing condition monitoring, and auto tire inflation functionality.

The present disclosure will now be described more fully hereinafter with reference to the accompanying drawings, which form a part hereof, and which show, by way of non-limiting illustration, certain examples. Subject matter may, however, be described in a variety of different forms and, therefore, covered or claimed subject matter is intended to be construed as not being limited to any examples set forth herein. Among other things, subject matter may be described as methods, devices, components, or systems. Accordingly, examples may take the form of hardware, software, firmware or any combination thereof (other than software per se). The following detailed description is, therefore, not intended to be taken in a limiting sense.

The examples of the direct drive wheel end generator system disclosed herein may be utilized in various vehicles including passenger vehicles such as a car, a SUV, or a truck. The direct drive wheel end generator system may also be used in commercial vehicles such as a tractor, a trailer, a tractor-trailer, a box truck, and a bus as examples. The direct drive wheel end generator system may be used in conjunction with wheels that are non-driven or wheels that are driven by a vehicle drivetrain or an electric motor. Further examples of vehicles for the direct drive wheel end generator system include mobile railway assets such as locomotives and rail cars. For purposes of this disclosure, the direct drive wheel end generator system will be described with respect to non-driven wheels of a trailer.

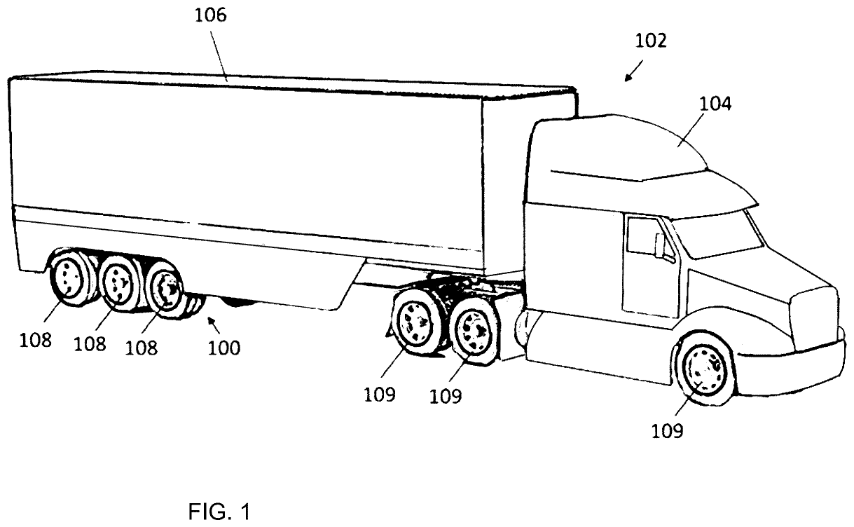

Referring now to FIG. 1, a view of semi-truck 102, which may include a tractor 104 and a trailer 106 having a regenerative system that includes the direct drive wheel end generator system 100 is shown. While the following discussion describes an example application where the direct drive wheel end generator system 100 is coupled to a wheel 108 of the trailer 106, those having skill in the art will readily appreciate that the disclosed direct drive wheel end generator system 100 may be utilized with any one or more of the wheels 109 of the tractor 104 or the wheels 108 of the trailer 106 of the semi-truck 102.

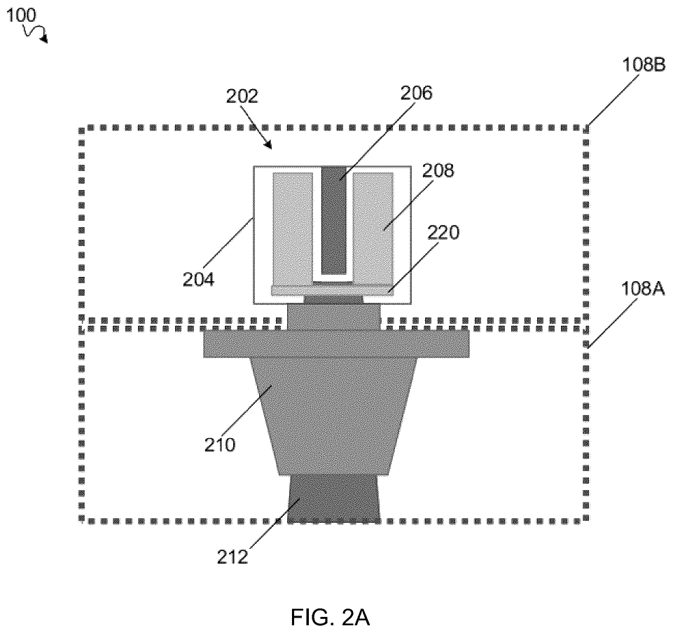

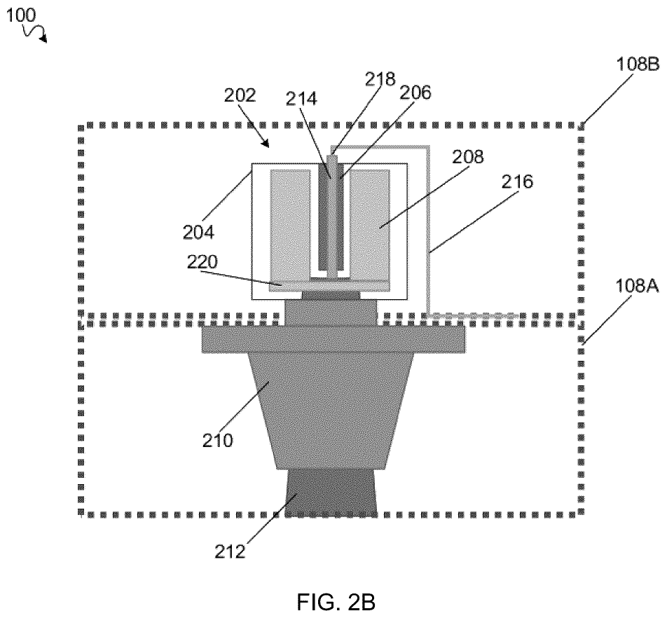

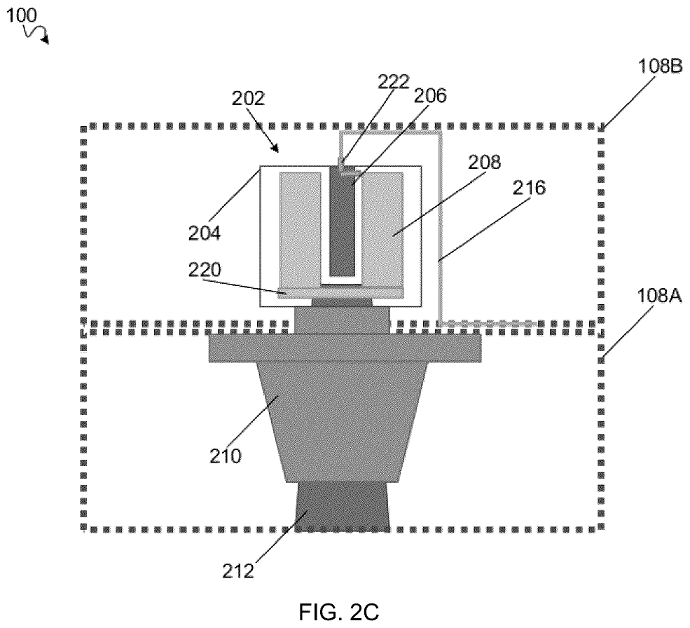

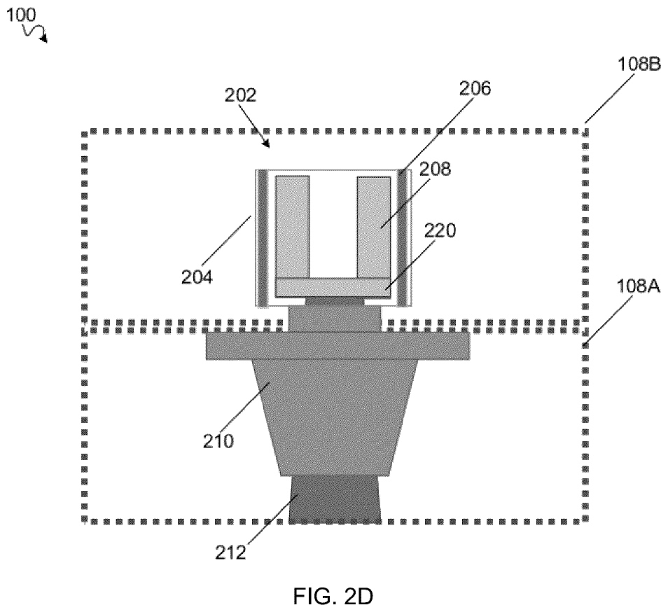

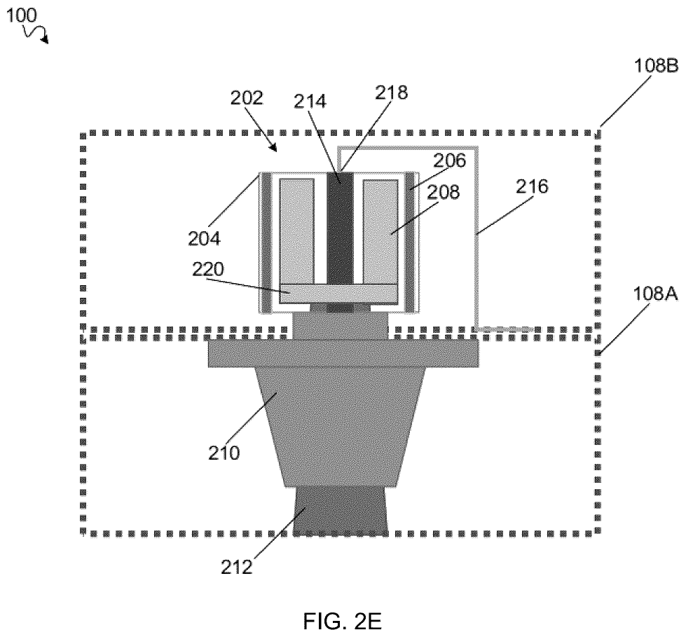

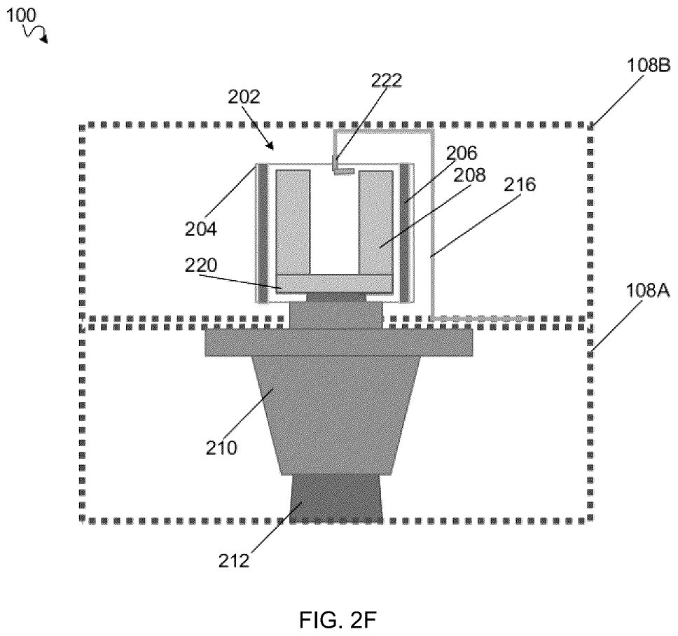

Referring now to FIGS. 2A-2C, top views of different examples a first type of the direct drive wheel end generator system 100 is shown. As shown in FIG. 2A, the first type of direct drive wheel end generator system 100 may include an electric generator 202 that is a radial flux motor.

The electric generator 202 may be coupled to a hub 210 and a spindle 212. The spindle 212 may be stationary and may have an interior opening (not shown) extending down its length. The hub 210 may rotate around the spindle 212. An inner wheel 108A and an outer wheel 108B may be connected to the hub 210 via one or more wheel studs (not shown).

The electric generator 202 may include a housing 204 that encloses a rotor 206 and one or more stator windings 208. The housing 204 may have an outer diameter that is smaller than an inner diameter of a center opening in one or more of the inner wheel 108A and the outer wheel 108B, such that the housing 204 fits within the center opening. This may allow for one or more of the inner wheel 108A and the outer wheel 108B to be removed without having to remove the housing 204 and/or the electric generator 202. The rotor 206 and the one or more stator windings 208 may both be orientated such that a majority of their lengths are parallel with a longitudinal axis that runs a length of the spindle 212. The housing 204 may be coupled directly to the hub 210. In an example, the housing 204 may have one or more holes (not shown) corresponding to one or more holes (not shown) on the hub 210 that are typically used for a hub cab cover and allow for it to be secured to the hub 210. The rotor 206 may include one or more magnets and may be connected to the housing 204. The rotor 206 may rotate with the hub 210 and the housing 204. The one or more stator windings 208 may be coupled to the spindle 212 and may remain stationary. In an example, the one or more stator windings 208 may be connected to a central stator 220, which may be directly coupled to the spindle 212. The central stator 220 may be coupled to the spindle 212 through a spindle keyway. In an example, the central stator 220 may have a tab (either as part of the central stator 220 or a component that is inserted into the central stator 220) that fits inside the spindle keyway to secure it to the spindle 212. Additionally, or alternatively, the central stator 220 may be secured to the spindle via one or more castle pins. One or more wires (not shown) coupled to the one or more stator windings 208 may be routed through the interior opening (not shown) of the spindle 212.

FIG. 2B shows an example of the first type of the direct drive wheel end generator system 100 that is configured to incorporate an automatic tire inflator system. The direct drive wheel end generator system 100 shown in FIG. 2B may be similar to direct drive wheel end generator system 100 shown in FIG. 2A but may incorporate a hollow shaft 214 that extends through an entire longitudinal axis of the rotor 206. The hollow shaft 214 may extended through an opening in the housing 204 and may be coupled to a tube 216 for the automatic tire inflator system via a connection 218. The hollow shaft 214 may remain stationary. In an example, the connection 218 may be a rotary union connection. The tube 216 for the automatic tire inflator system may then extend into one or more of the inner wheel 108A and the outer wheel 108B. The hollow shaft 214 may be coupled to a pressurized air brake system. In an example, the spindle 212 may have one or more hollow tubes running along an interior length. The one or more hollow tubes may extend across an entire length of the spindle 212 (e.g., from the hub 210 to a hub on an opposite side of the trailer). One or more holes may be drilled in the spindle 212 to access the one or more hollow tubes, which may then be connected to a conventional pressurized air system (e.g., air brakes or auto-inflation system).

FIG. 2C shows another example of the first type of the direct drive wheel end generator system 100 that is configured to incorporate an automatic tire inflator system. The direct drive wheel end generator system 100 shown in FIG. 2B may be similar to direct drive wheel end generator system 100 shown in FIG. 2A, but rather than having the hollow shaft 214, the entire housing 204 may be coupled to the one or more hollow tubes within the spindle 212 and pressurized as described above. A connector 222 may be coupled to the housing 204 and the tube 216 for the automatic tire inflator system.

Referring now to FIGS. 2D-2F, top views of different examples of a second type of the direct drive wheel end generator system 100 is shown. Like the first type of the direct drive wheel end generator system 100 illustrated in FIGS. 2A-2C, the second type of the direct drive wheel end generator system 100 may be a radial flux motor and may include similar components. However, the second type of the direct drive wheel end generator system 100 may be an “outrunner” type of radial flux motor in which the rotor 206 is cylindrical in shape and surrounds the one or more stator windings 208. The rotor 206 may be attached to the housing 204 via adhesive and may rotate with the housing 204 around the one or more stator windings 208. FIG. 2D shows the second type of the direct drive wheel end generator system 100. FIG. 2E shows the second type of the direct drive wheel end generator system 100 configured to incorporate the automatic tire inflator system using the hollow shaft 214 as described above. FIG. 2F shows the second type of the direct drive wheel end generator system 100 configured to incorporate the automatic tire inflator system in which the entire house 204 is pressurized, as described above.

The electric generator 202 may be sensorless (e.g., no resolver or encoder), which may reduce the number of wires required to electrically couple the direct drive wheel end generator system 100 to the trailer and/or vehicle components. Because the electric generator 202 is not powered and there may be a minimum speed requirement for engagement, a resolver/encoder may not be needed for the electric generator 202 to work properly with components of the vehicle's electrical system (e.g., an inverter).

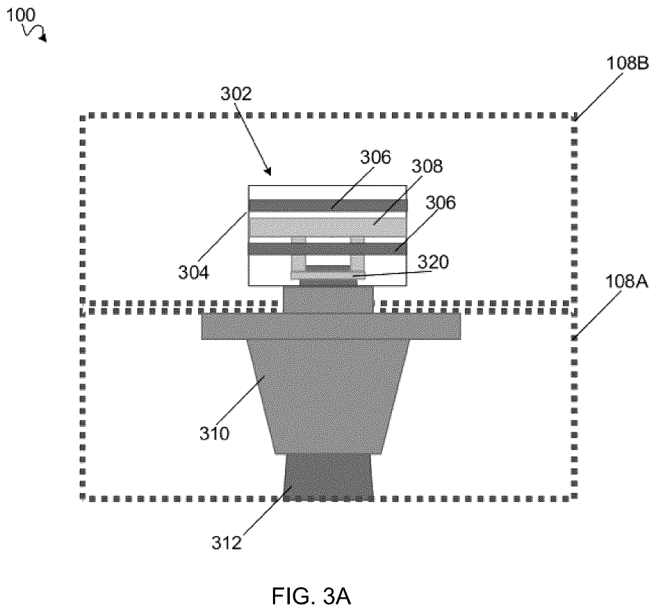

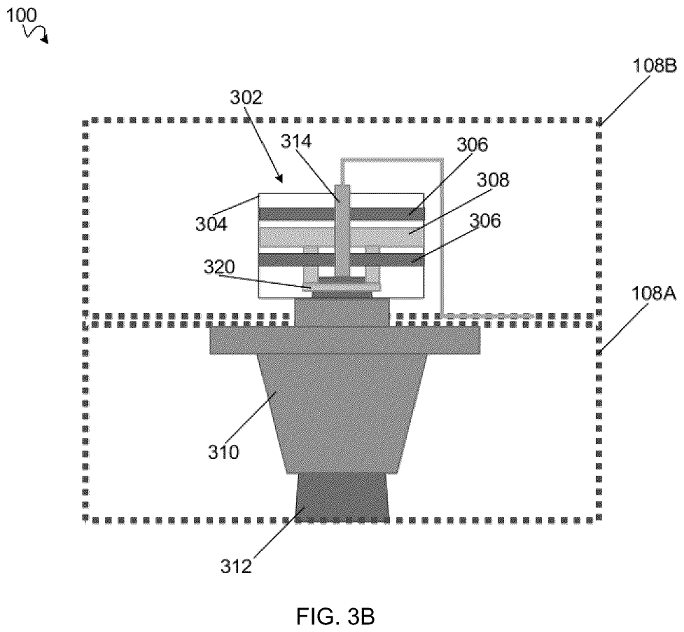

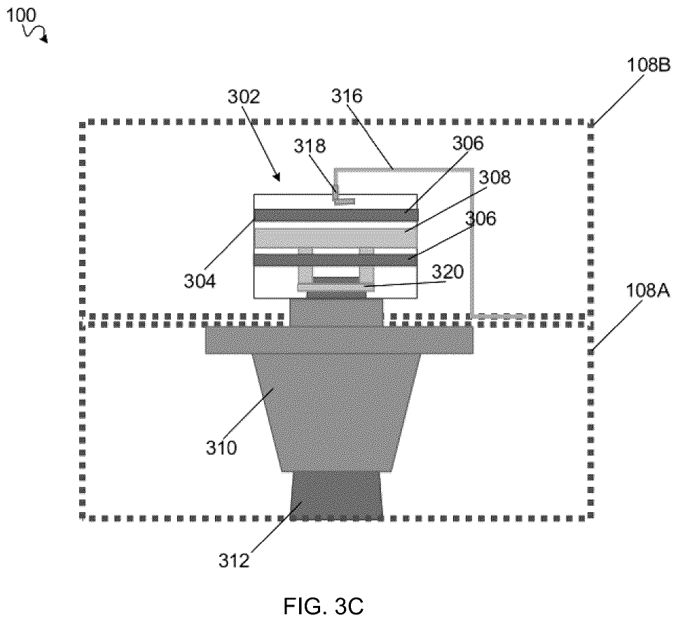

Referring now to FIGS. 3A-3C, top views of different examples of a third type of the direct drive wheel end generator system 100 is shown. As shown in FIG. 3A, the third type of direct drive wheel end generator system 100 may include an electric generator 302 that is an axial flux motor. The electric generator 302 may be coupled to a hub 310 and a spindle 312. The spindle 312 may be stationary and may have an interior opening (not shown) extending down its length. The hub 310 may rotate around the spindle 312. The inner wheel 108A and the outer wheel 108B may be connected to the hub 310 via one or more wheel studs (not shown).

The electric generator 302 may include a housing 304 that encloses one or more rotors 306 and one or more stator windings 308. The housing 304 may have an outer diameter that is smaller than an inner diameter of a center opening in one or more of the inner wheel 108A and the outer wheel 108B, such that the housing 304 fits within the center opening. This may allow for one or more of the inner wheel 108A and the outer wheel 108B to be removed without having to remove the housing 304 and/or the electric generator 302. The one or more rotors 306 and the one or more stator windings 308 may both be orientated such that a majority of their lengths are perpendicular with a longitudinal axis that runs a length of the spindle 312. The housing 304 may be coupled directly to the hub 310. In an example, the housing 304 may have one or more holes (not shown) corresponding to one or more holes (not shown) on the hub 310 that are typically used for a hub cab cover and allow for it to be secured to the hub 310. The one or more rotors 306 may include one or more magnets and may be connected to the housing 304. The one or more rotors 306 may rotate with the hub 310 and the housing 304. The one or more stator windings 308 may be coupled to the spindle 312 and may remain stationary. In an example, the one or more stator windings 308 may be connected to a central stator 320, which may be directly coupled to the spindle 312. The central stator 320 may be coupled to the spindle 312 through a spindle keyway. In an example, the central stator 320 may have a tab (either as part of the central stator 320 or a component that is inserted into the central stator 320) that fits inside the spindle keyway to secure it to the spindle 312. Additionally, or alternatively, the central stator 320 may be secured to the spindle via one or more castle pins. It should be noted that FIG. 3A shows two rotors 306 and a single stator winding 308, but any number of each component are contemplated and may be adjusted (e.g., depending on power requirements and/or efficiency). One or more wires (not shown) coupled to the one or more stator windings 308 may be routed through the interior opening (not shown) of the spindle 312.

FIG. 3B shows an example of the first type of the direct drive wheel end generator system 100 that is configured to incorporate an automatic tire inflator system. The direct drive wheel end generator system 100 shown in FIG. 3B may be similar to direct drive wheel end generator system 100 shown in FIG. 3A but may incorporate a hollow shaft 314 that extends through a center opening created by the central stator 320 and the one or more stator windings 308. The hollow shaft 314 may extend through an opening in the housing 304 and may be coupled to a tube 316 for the automatic tire inflator system via a connection 318. The hollow shaft 314 may remain stationary. In an example, the connection 318 may be a rotary union connection. The tube 316 for the automatic tire inflator system may then extend into one or more of the inner wheel 108A and the outer wheel 108B. The hollow shaft 314 may be coupled to a pressurized air brake system. In an example, the spindle 312 may have one or more hollow tubes running along an interior length. The one or more hollow tubes may extend across an entire length of the spindle 312 (e.g., from the hub 310 to a hub on an opposite side of the trailer). One or more holes may be drilled in the spindle 312 to access the one or more hollow tubes, which may then be connected to a conventional pressurized air system (e.g., air brakes or auto-inflation system).

FIG. 3C shows another example of the first type of the direct drive wheel end generator system 100 that is configured to incorporate an automatic tire inflator system. The direct drive wheel end generator system 100 shown in FIG. 3B may be similar to direct drive wheel end generator system 100 shown in FIG. 3A, but rather than having the hollow shaft 314, the entire housing 304 may be coupled to the one or more hollow tubes within the spindle 312 and may pressurized as described above. A connector 318 may be coupled to the housing 304 and the tube 316 for the automatic tire inflator system.

The electric generator 302 may be sensorless (e.g., no resolver or encoder), which may reduce the number of wires required to electrically couple the direct drive wheel end generator system 100 to the trailer and/or vehicle components. Because the electric generator 302 is not powered and there may be a minimum speed requirement for engagement, a resolver/encoder may not be needed for the electric generator 302 to work properly with components of the vehicle's electrical system (e.g., an inverter).

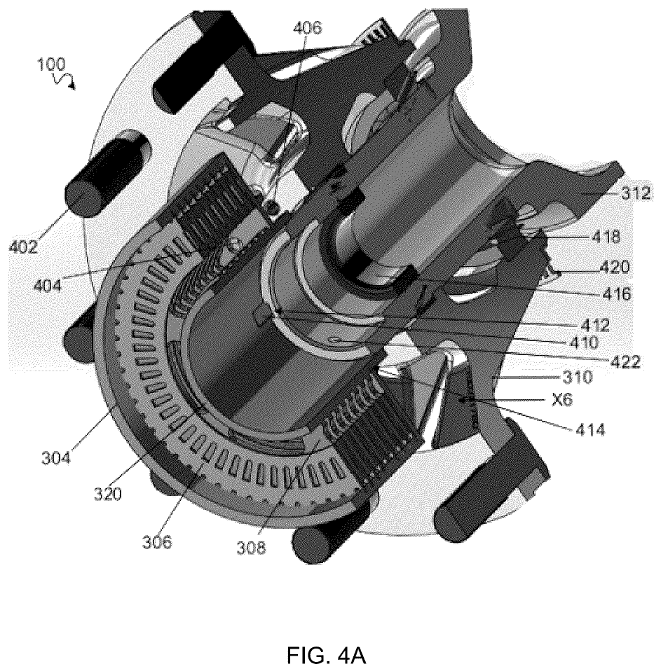

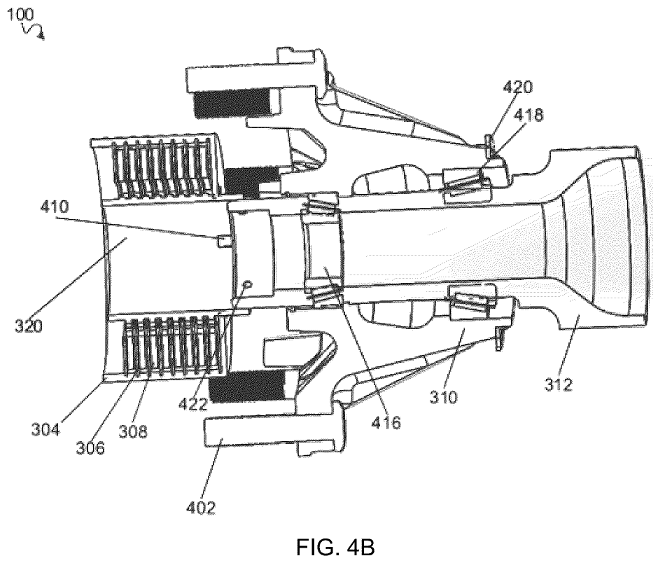

Referring now to FIGS. 4A-4B, a perspective view and a cross section view of the third type of direct drive wheel end generator system 100 is shown. FIGS. 4A-4B are shown from a vertical cross-section taken from a centerline of the direct drive wheel end generator system 100 for clarity.

As described above, the housing 304 may be coupled directly to the hub 310. The housing 304 may have one or more holes 404 corresponding to one or more holes 406 on the hub 310 that are typically used for a hub cab cover and allow for it to be secured to the hub 310. As described above, the hub 310 may include one or more wheel studs 402. In an example, an outer edge of each of the one or more rotors 306 may be secured to the housing 304 via adhesive and/or fasteners, either individually or as a group. The one or more stator windings 308 may be connected to the central stator 320 and may extend outward from between the one or more rotors 306. The central stator 320 may be substantially cylindrical in shape. The central stator 320 may be connected to the spindle 312 via a tab 410 that extends into a spindle keyway 412. The tab 410 may be machined into the central stator 320 or it may be added during assembly. The central stator 320 may have a groove 414 that receives a portion of the housing 304 and allows the housing 304 to rotate. A first spindle bearing 416 and a second spindle bearing 418 may allowed for the hub 310 to rotate around the spindle 312. A rotary encoder 420 for an ABS system may be coupled to the hub 310. The spindle 312 may include a cotter pin hole 422, which may be an alternative means of securing the hub 310 via a cotter pin.

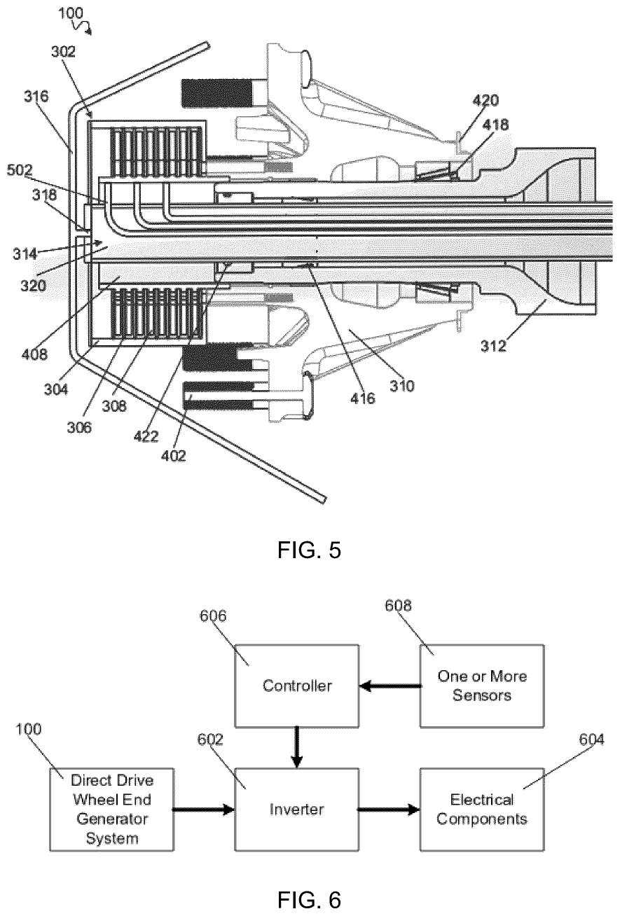

Referring now to FIG. 5, a cross section view of the third type of direct drive wheel end generator system 100, as described above with references to FIGS. 4A-4B, configured to incorporate an automatic tire inflator system is shown. As described above with reference to FIG. 3B, the direct drive wheel end generator system 100 may incorporate a hollow shaft 314 that extends through the center opening created by the central stator 320 and the one or more stator windings 308. The hollow shaft 314 may extend through an opening in the housing 304 and may be coupled to a tube 316 for the automatic tire inflator system via the connection 318. The tube 316 for the automatic tire inflator system may then extend into one or more of the inner wheel 108A and the outer wheel 108B. As described above, the hollow shaft 314 may be coupled to a pressurized air system via one or more hollow shafts in the spindle 312. One or more wires 502 coupled to the one or more stator windings 308 may be routed through the hollo shaft 314 and into an interior opening of the spindle 312. In an example, and as shown in FIG. 5, the one or more wires 502 may extend through one or more openings in the hollow shaft 314 without loss of pressurization.

Referring now to FIG. 6, a component diagram of an electrical system incorporating the direct drive wheel end generator system 100 is shown. The direct drive wheel end generator system 100 may be coupled to an inverter 602 by, for example, the one or more wires 502. The inverter 602 may be configured to receive power from the direct drive wheel end generator system 100 and distribute the power to one or more electrical components 604 (e.g., a primary drive system, one or more accessories, one or more batteries, etc.) according to one or more modes of operation.

In an example, the one or more modes of operation may include off, through the road (“TTR”) charging, and regeneration. In the off mode, the inverter 602 may not provide any power to the one or more electrical components 604. In the TTR charging mode, the inverter 602 may constantly add a slight load to the primary drive system. In regeneration mode, the inverter 602 may ensure there is no extra load placed on the primary drive system, so it is only engaged in deceleration, braking, downhill coasting, etc.

The one or more modes of operation may be controlled by a controller 606, which receives input from one or more sensors 608. The one or more sensors may include a GPS device, a device that provides a state of charge (SOC) for one or more batteries, a speedometer, an accelerometer, an inclinometer, and one or more devices that can detect a status of brakes of the semi-truck 102. In an example, the one or more one or more devices that can detect a status of the brakes of the semi-truck 102 may be one or more of an ABS controller, a pressure sensor on brake lines, and the brake light wiring and/or components coupled to each of these.

In an example, the controller 606 may trigger the regeneration mode of operation after determining by, for example the accelerometer and/or inclinometer, that the semi-truck 102 is coasting or traveling downhill. In another example, the controller 606 may disengage the TTR charging mode of operation and allow only the regeneration mode of operation based on geofencing information received by the GPS device. In another example, the controller 606 may cause the inverter 604 to enter the off mode of operation upon one or more of a detection of an ABS, when lateral acceleration of the semi-truck 102 is above a certain level, when the inclinometer or GPS device indicates an incline is being ascended, when a minimum speed threshold or maximum speed threshold is reached, and when a battery SOC maximum setpoint is reached.

The methods described herein, including those with reference to one or more flowcharts, may be performed by a controller and/or processing device (e.g., smartphone, computer, etc.). The methods may include one or more operations, functions, or actions as illustrated in one or more of blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation. Dashed lines may represent optional and/or alternative steps.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure. Components and/or arrangement of components illustrated in one figure may be incorporated into any other figure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The terms “including” and “comprising” should be interpreted as meaning “including, but not limited to.” If not already set forth explicitly in the claims, the term “a” should be interpreted as “at least one” and the terms “the, said, etc.” should be interpreted as “the at least one, said at least one, etc.”

It is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A system comprising:
a housing adapted to be coupled to a wheel hub; and
an electric generator within the housing, the electric generator configured to produce electricity based on a rotation of the hub and housing around a stationary spindle, the electric generator comprising:
one or more rotors coupled to the housing, and
one or more stator windings coupled to the spindle.

2. The system of claim 1, wherein the housing is coupled to the hub via one or more fasteners extending through one or more holes in the housing and one or more corresponding holes in the hub.

3. The system of claim 1, wherein the electric generator comprises a radial flux motor.

4. The system of claim 3, wherein the one more rotors and the one or more stator windings are orientated such that a majority of their lengths are parallel with a longitudinal axis of the spindle.

5. The system of claim 3, wherein the one or more rotors comprise a single rotor aligned with a longitudinal axis of the spindle.

6. The system of claim 5, wherein the one or more rotors comprise a hollow shaft that extends through an entire longitudinal axis of the one or more rotors.

7. The system of claim 6, wherein the hollow shaft extends through an opening in the housing and is coupled to a tube for an automatic tire inflator system.

8. The system of claim 4, wherein an interior of the housing is pressurized and is coupled to a tube for an automatic tire inflator system.

9. The system of claim 4, wherein the one or more rotors comprise a single cylindrical rotor coupled to the housing and surrounding the one or more stator windings.

10. The system of claim 9, further comprising a hollow shaft that extends through an opening in the housing and is coupled to a tube for an automatic tire inflator system.

11. The system of claim 1, wherein the electric generator comprises an axial flux motor.

12. The system of claim 11, wherein an interior of the housing is pressurized and is coupled to a tube for an automatic tire inflator system.

13. The system of claim 11, wherein the one or more rotors and the one or more stator windings are orientated such that a majority of their lengths are perpendicular with a longitudinal axis that runs a length of the spindle.

14. The system of claim 13, wherein the one or more stator windings are connected to a central stator that is substantially cylindrical in shape.

15. The system of claim 14, wherein the central stator is connected to the spindle via a tab that inserts into a keyway on the spindle.

16. The system of claim 14, further comprising a hollow shaft extending through a middle opening of the central stator.

17. The system of claim 16, wherein the hollow shaft extends through an opening in the housing and is coupled to a tube for an automatic tire inflator system.

18. The system of claim 1, wherein the electric generator is sensorless.

19. The system if claim 1, further comprising:
an inverter coupled to the electric generator via one or more wires, and configured is to deliver power from the electric generator to one or more electrical components; and
a controller coupled to the inverter, the controller configured to determine a mode of operation of the inverter, wherein the mode of operation of the inverter comprises one of: off, through the road (TTR) charging, and regeneration.

20. The system of claim 19, wherein the determine the mode of operation of the inverter is based on input from one or more sensors coupled to the controller, wherein the one or more sensors comprise a GPS device, a device that provides a state of charge (SOC) for one or more batteries, a speedometer, an accelerometer, an inclinometer, and/or one or more devices that can detect a status of brakes.
